(19) United States
(12) Patent Application Publication
(10) Pub. No.: US 2021/0118144 A1
(43) Pub. Date: Apr. 22, 2021

(54) IMAGE PROCESSING METHOD, ELECTRONIC DEVICE, AND STORAGE MEDIUM

(71) Applicant: Beijing Sensetime Technology Development Co., Ltd., Beijing (CN)

(72) Inventors: Jiahui LI, Beijing (CN); Zhiqiang HU, Beijing (CN)

(21) Appl. No.: 17/135,489

(22) Filed: Dec. 28, 2020

Related U.S. Application Data
(63) Continuation of application No. PCT/CN2019/105787, filed on Sep. 12, 2019.

(30) Foreign Application Priority Data
Sep. 15, 2018 (CN) 201811077349.X
Sep. 15, 2018 (CN) 201811077358.9

(51) Int. Cl. G06T 7/11; G06T 7/00; G06K 9/00

(52) U.S. Cl. CPC G06T 7/11; G06T 7/0012; G06T 2207/30024; G06T 2207/10056; G06K 9/0014

(57) ABSTRACT

Embodiments of the present disclosure disclose image processing methods, electronic devices, and a storage medium. According to one example of the method, an electronic device may: process a first image to obtain prediction results of a plurality of pixels in the first image, the prediction results including semantic prediction results and center relative position prediction results, wherein the semantic prediction results indicate that the pixels are located in an instance region or a background region, and the center relative position prediction results indicate relative positions between the pixels and an instance center; and determine an instance segmentation result of the first image based on the semantic prediction result and the center relative position prediction result of each of the plurality of pixels.

### CROSS REFERENCE TO RELATED APPLICATIONS

This application is a continuation application of International Patent Application No. PCT/CN2019/105787, filed on Sep. 12, 2019, which is based on and claims priority to and benefit of Chinese Patent Application No. 201811077349.X, filed with the China National Intellectual Property Administration (CNIPA) on Sep. 15, 2018 and entitled “IMAGE PROCESSING METHOD, ELECTRONIC DEVICE, AND STORAGE MEDIUM”, and Chinese Patent Application No. 201811077358.9, filed with the CNIPA on Sep. 15, 2018 and entitled “IMAGE PROCESSING METHOD, ELECTRONIC DEVICE, AND STORAGE MEDIUM.” The content of all of the above-identified applications is incorporated herein by reference in their entirety.

### TECHNICAL FIELD

The present disclosure relates to the field of computer vision technologies, in particular, to image processing methods, electronic devices, and a storage medium.

### BACKGROUND

Image processing is a technology in which an image is analyzed by a computer to achieve a desired result. Image processing generally refers to digital image processing. A digital image refers to one two-dimensional array captured by a device such as an industrial camera, a video camera, or a scanner. The elements of the array are called pixels, and their values are called grayscale values. Image processing has very important functions in many fields, especially the processing of medical images.

### SUMMARY

Embodiments of the present disclosure provide image processing methods, electronic devices, and a storage medium.

An image processing method is provided according to a first aspect of the embodiments of the present disclosure, including: processing a first image to obtain prediction results of a plurality of pixels in the first image, wherein the prediction results include semantic prediction results and center relative position prediction results, wherein the semantic prediction results indicate that the pixels are located in an instance region or a background region, and the center relative position prediction results indicate relative positions between the pixels and an instance center; and determining an instance segmentation result of the first image based on the semantic prediction result and the center relative position prediction result of each of the plurality of pixels.

In some embodiments, processing the first image to obtain the semantic prediction results of the plurality of pixels in the first image includes: processing the first image to obtain instance region prediction probabilities of the plurality of pixels in the first image, wherein the instance region prediction probabilities indicate probabilities of the pixels being located in the instance region; and performing binarization processing on the instance region prediction probabilities of the plurality of pixels based on a second threshold to obtain a semantic prediction result of each of the plurality of pixels.

In some embodiments, an instance center region includes a region within the instance region and smaller than the instance region, and the geometric center of the instance center region overlaps the geometric center of the instance region.

In one example implementation, before processing the first image, the method further includes: preprocessing a second image to obtain the first image, so that the first image satisfies a preset contrast ratio and/or a preset grayscale value.

In one example implementation, before processing the first image, the method further includes: preprocessing the second image to obtain the first image, so that the first image satisfies a preset image size.

In one example implementation, determining the instance segmentation result of the first image based on the semantic prediction result and the center relative position prediction result of each of the plurality of pixels includes: determining at least one first pixel located in the instance region from the plurality of pixels based on the semantic prediction result of each of the plurality of pixels; and determining an instance to which each of the at least one first pixel belongs based on the center relative position prediction result of the first pixel.

The instance is a segmentation object in the first image, and may specifically be a closed structure in the first image.

The instance in the embodiments of the present disclosure includes a cell nucleus, that is, the embodiments of the present disclosure may be applied to cell nucleus segmentation.

In one example implementation, the prediction results further includes center region prediction results, and the center region prediction results indicate whether the pixels are located in an instance center region; the method further includes: determining at least one instance center region of the first image based on the center region prediction result of each of the plurality of pixels; and determining the instance to which each of the at least one first pixel belongs based on the center relative position prediction result of the first pixel includes: determining an instance center region corresponding to each of the at least one first pixel from the at least one instance center region based on the center relative position prediction result of the first pixel.

In one example implementation, determining the at least one instance center region of the first image based on the center region prediction result of each of the plurality of pixels includes: performing connected component search processing on the first image based on the center region prediction result of each of the plurality of pixels to obtain the at least one instance center region.

In one example implementation, performing connected component search processing on the first image based on the center region prediction result of each of the plurality of pixels to obtain the at least one instance center region includes: performing connected component search processing on the first image by a random walk algorithm based on the center region prediction result of each of the plurality of pixels to obtain the at least one instance center region.

In one example implementation, determining the instance center region corresponding to each of the at least one first pixel from the at least one instance center region based on the center relative position prediction result of the first pixel includes: determining a center prediction position of the first pixel based on position information of the first pixel and the center relative position prediction result of the first pixel; and determining the instance center region corresponding to the first pixel from the at least one instance center region based on the center prediction position of the first pixel and position information of the at least one instance center region.

In one example implementation, determining the instance center region corresponding to the first pixel from the at least one instance center region based on the center prediction position of the first pixel and the position information of the at least one instance center region includes: in response to the center prediction position of the first pixel belonging to a first instance center region in the at least one instance center region, determining the first instance center region as the instance center region corresponding to the first pixel; or, in response to the center prediction position of the first pixel not belonging to any instance center region in the at least one instance center region, determining an instance center region closest to the center prediction position of the first pixel in the at least one instance center region as the instance center region corresponding to the first pixel.

In one example implementation, processing the first image to obtain the prediction results of the plurality of pixels in the first image includes: processing the first image to obtain center region prediction probabilities of the plurality of pixels in the first image; and performing binarization processing on the center region prediction probabilities of the plurality of pixels based on a first threshold to obtain the center region prediction result of each of the plurality of pixels.

In one example implementation, processing the first image to obtain the prediction results of the plurality of pixels in the first image includes: inputting the first image to a neural network for processing to output the prediction results of the plurality of pixels in the first image.

An electronic device is provided according to a second aspect of the embodiments of the present disclosure, including: a predicting module and a segmenting module, wherein the predicting module is configured to process a first image to obtain prediction results of a plurality of pixels in the first image, wherein the prediction results include semantic prediction results and center relative position prediction results, wherein the semantic prediction results indicate that the pixels are located in an instance region or a background region, and the center relative position prediction results indicate relative positions between the pixels and an instance center; and the segmenting module is configured to determine an instance segmentation result of the first image based on the semantic prediction result and the center relative position prediction result of each of the plurality of pixels.

In some embodiments, the predicting module is configured to: process the first image to obtain instance region prediction probabilities of the plurality of pixels in the first image, wherein the instance region prediction probabilities indicate probabilities of the pixels being located in the instance region; and performing binarization processing on the instance region prediction probabilities of the plurality of pixels based on a second threshold to obtain a semantic prediction result of each of the plurality of pixels.

In one example implementation, the electronic device further includes a preprocessing module, configured to preprocess a second image to obtain the first image, so that the first image satisfies a preset contrast ratio and/or a preset grayscale value.

In one example implementation, the preprocessing module is further configured to preprocess the second image to obtain the first image, so that the first image satisfies a preset image size.

In one example implementation, the segmenting module includes a first unit and a second unit, wherein the first unit is configured to determine at least one first pixel located in the instance region from the plurality of pixels based on the semantic prediction result of each of the plurality of pixels; and the second unit is configured to determine an instance to which each of the at least one first pixel belongs based on the center relative position prediction result of the first pixel.

In one example implementation, the prediction results further includes center region prediction results, and the center region prediction results indicate whether the pixels are located in an instance center region; the segmenting module further includes a third unit, configured to determine at least one instance center region of the first image based on the center region prediction result of each of the plurality of pixels; and the second unit is specifically configured to determine an instance center region corresponding to each of the at least one first pixel from the at least one instance center region based on the center relative position prediction result of the first pixel.

In one example implementation, the third unit is specifically configured to perform connected component search processing on the first image based on the center region prediction result of each of the plurality of pixels to obtain the at least one instance center region.

In one example implementation, the third unit is specifically configured to perform connected component search processing on the first image by a random walk algorithm based on the center region prediction result of each of the plurality of pixels to obtain the at least one instance center region.

In one example implementation, the second unit is specifically configured to: determine a center prediction position of the first pixel based on position information of the first pixel and the center relative position prediction result of the first pixel; and determine the instance center region corresponding to the first pixel from the at least one instance center region based on the center prediction position of the first pixel and position information of the at least one instance center region.

In one example implementation, the second unit is specifically configured to: in response to the center prediction position of the first pixel belonging to a first instance center region in the at least one instance center region, determine the first instance center region as the instance center region corresponding to the first pixel.

In one example implementation, the second unit is specifically configured to: in response to the center prediction position of the first pixel not belonging to any instance center region in the at least one instance center region, determine an instance center region closest to the center prediction position of the first pixel in the at least one instance center region as the instance center region corresponding to the first pixel.

In one example implementation, the predicting module includes a probability predicting unit and a judging unit, wherein the probability predicting unit is configured to process the first image to obtain center region prediction probabilities of the plurality of pixels in the first image; and the judging unit is configured to perform binarization processing on the center region prediction probabilities of the plurality of pixels based on a first threshold to obtain the center region prediction result of each of the plurality of pixels.

In one example implementation, the predicting module is specifically configured to input the first image to a neural network for processing to output the prediction results of the plurality of pixels in the first image.

In the embodiments of the present disclosure, an instance segmentation result of a first image is determined based on a semantic prediction result and a center relative position prediction result of each of the plurality of pixels included in the first image, and thus, instance segmentation in image processing has the advantages of high speed and high accuracy.

An image processing method is provided according to a third aspect of the embodiments of the present disclosure, The method includes: obtaining N groups of instance segmentation output data, wherein the N groups of instance segmentation output data are instance segmentation output results obtained by processing an image by N instance segmentation models, respectively, the N groups of instance segmentation output data have different data structures, and N is an integer greater than 1; obtaining integrated semantic data and integrated center region data of the image based on the N groups of instance segmentation output data, wherein the integrated semantic data indicates a pixel located in an instance region in the image, and the integrated center region data indicates a pixel located in an instance center region in the image; and obtaining an instance segmentation result of the image based on the integrated semantic data and the integrated center region data of the image.

In one example implementation, obtaining the integrated semantic data and the integrated center region data of the image based on the N groups of instance segmentation output data includes: obtaining, for each of the N instance segmentation models, semantic data and center region data of the instance segmentation model based on the instance segmentation output data of the instance segmentation model; and obtaining the integrated semantic data and the integrated center region data of the image based on the semantic data and the center region data of each of the N instance segmentation models.

In one example implementation, obtaining the semantic data and the center region data of the instance segmentation model based on the instance segmentation output data of the instance segmentation model includes: determining instance identification information corresponding to each of a plurality of pixels in the image in the instance segmentation model based on the instance segmentation output data of the instance segmentation model; and obtaining a semantic prediction value of each of the plurality of pixels in the instance segmentation model based on the instance identification information corresponding to each of the plurality of pixels in the instance segmentation model, wherein the semantic data of the instance segmentation model comprises the semantic prediction value of each of the plurality of pixels in the image.

In one example implementation, obtaining the semantic data and the center region data of the instance segmentation model based on the instance segmentation output data of the instance segmentation model further includes: determining, in the instance segmentation model, at least two pixels located in the instance region in the image based on the instance segmentation output data of the instance segmentation model; determining an instance center position of the instance segmentation model based on position information of the at least two pixels located in the instance region in the instance segmentation model; and determining an instance center region of the instance segmentation model based on the instance center position of the instance segmentation model and the position information of the at least two pixels.

In one example implementation, before determining, in the instance segmentation model, the at least two pixels located in the instance region in the image based on the instance segmentation output data of the instance segmentation model, further includes: obtaining eroded data of the instance segmentation model by performing erosion processing on the instance segmentation output data of the instance segmentation model. In this case, determining, in the instance segmentation model, the at least two pixels located in the instance region in the image based on the instance segmentation output data of the instance segmentation model includes: determining, in the instance segmentation model, the at least two pixels located in the instance region in the image based on the eroded data of the instance segmentation model.

In one example implementation, determining the instance center position of the instance segmentation model based on the position information of the at least two pixels located in the instance region in the instance segmentation model includes: taking an average value of the positions of the at least two pixels located in the instance region as the instance center position of the instance segmentation model.

In one example implementation, determining the instance center region of the instance segmentation model based on the instance center position of the instance segmentation model and the position information of the at least two pixels includes: determining a maximum distance among the at least two pixels and the instance center position based on the instance center position of the instance segmentation model and the position information of the at least two pixels; determining a first threshold based on the maximum distance; and determining a pixel in the at least two pixels which has a distance from the instance center position being less than or equal to the first threshold as a pixel in the instance center region.

In one example implementation, obtaining the integrated semantic data and the integrated center region data of the image based on the semantic data and the center region data of each of the N instance segmentation models includes: determining a semantic voting value of each of the plurality of pixels in the image based on the semantic data of each of the N instance segmentation models; and performing binarization processing on the semantic voting value of each of the plurality of pixels to obtain an integrated semantic value of each pixel in the image, wherein the integrated semantic data of the image includes the integrated semantic value of each of the plurality of pixels.

In one example implementation, performing the binarization processing on the semantic voting value of each of the plurality of pixels to obtain the integrated semantic value of each pixel in the image includes: determining a second threshold value based on the number N of the multiple instance segmentation models; and performing the binarization processing on the semantic voting value of each of the plurality of pixels based on the second threshold to obtain the integrated semantic value of each pixel in the image.

In one example implementation, the second threshold is a round-up result of N/2.

In one example implementation, obtaining the instance segmentation result of the image based on the integrated semantic data and the integrated center region data of the image includes: obtaining at least one instance center region of the image based on the integrated center region data of the image; and determining an instance to which each of the plurality of pixels in the image belongs based on the at least one instance center region and the integrated semantic data of the image.

In one example implementation, determining the instance to which each of the plurality of pixels in the image belongs based on the at least one instance center region and the integrated semantic data of the image includes: performing a random walk based on the integrated semantic value of each of the plurality of pixels in the image and the at least one instance center region to obtain the instance to which the pixel belongs.

An electronic device is provided according to a fourth aspect of the embodiments of the present disclosure. The device includes: an obtaining module, a converting module, and a segmenting module. The obtaining module is configured to obtain N groups of instance segmentation output data, wherein the N groups of instance segmentation output data are instance segmentation output results obtained by processing an image by N instance segmentation models, respectively, the N groups of instance segmentation output data have different data structures, and N is an integer greater than 1. The converting module is configured to obtain integrated semantic data and integrated center region data of the image based on the N groups of instance segmentation output data, wherein the integrated semantic data indicates a pixel located in an instance region in the image, and the integrated center region data indicates a pixel located in an instance center region in the image. The segmenting module is configured to obtain an instance segmentation result of the image based on the integrated semantic data and the integrated center region data of the image.

In one example implementation, the converting module includes a first converting unit and a second converting unit. The first converting unit is configured to obtain , for each of the N instance segmentation models, semantic data and center region data of the instance segmentation model based on the instance segmentation output data of the instance segmentation model; and the second converting unit is configured to obtain the integrated semantic data and the integrated center region data of the image based on the semantic data and the center region data of each of the N instance segmentation models.

In one example implementation, the first converting unit is specifically configured to: determine instance identification information corresponding to each of a plurality of pixels in the image in the instance segmentation model based on the instance segmentation output data of the instance segmentation model; and obtain a semantic prediction value of each of the plurality of pixels in the instance segmentation model based on the instance identification information corresponding to the pixel in the instance segmentation model, wherein the semantic data of the instance segmentation model includes the semantic prediction value of each of the plurality of pixels in the image.

In one example implementation, the first converting unit is further configured to: determine, in the instance segmentation model, at least two pixels located in the instance region in the image based on the instance segmentation output data of the instance segmentation model; determine an instance center position of the instance segmentation model based on position information of the at least two pixels located in the instance region in the instance segmentation model; and determine an instance center region of the instance segmentation model based on the instance center position of the instance segmentation model and the position information of the at least two pixels.

In one example implementation, the converting module further includes an erosion processing unit, configured to perform erosion processing on the instance segmentation output data of the instance segmentation model to obtain eroded data of the instance segmentation model; and the first converting unit is specifically configured to determine, in the instance segmentation model, the at least two pixels located in the instance region in the image based on the eroded data of the instance segmentation model.

In one example implementation, the first converting unit is specifically configured to use an average value of the positions of the at least two pixels located in the instance region as the instance center position of the instance segmentation model.

In one example implementation, the first converting unit is further configured to: determine a maximum distance between the at least two pixels and the instance center position based on the instance center position of the instance segmentation model and the position information of the at least two pixels; determine a first threshold based on the maximum distance; and determine a pixel in the at least two pixels which has a distance from the instance center position less than or equal to the first threshold as a pixel in the instance center region.

In one example implementation, the converting module is specifically configured to: determine a semantic voting value of each of the plurality of pixels in the image based on the semantic data of the instance segmentation model; and perform binarization processing on the semantic voting value of each of the plurality of pixels to obtain an integrated semantic value of each pixel in the image, wherein the integrated semantic data of the image includes the integrated semantic value of each of the plurality of pixels.

In one example implementation, the converting module is further configured to: determine a second threshold value based on the number N of the multiple instance segmentation models; and perform binarization processing on the semantic voting value of each of the plurality of pixels based on the second threshold to obtain the integrated semantic value of each pixel in the image.

In one example implementation, the second threshold is a round-up result of N/2.

Another electronic device is provided according to a fifth aspect of the embodiments of the present disclosure, including a processor and a memory, wherein the memory is configured to store a computer program, the computer program is configured to be executed by the processor, and the processor is configured to perform some of all of the steps described in any method according to the first aspect and the third aspect of the embodiments of the present disclosure.

A computer-readable storage medium is provided according to a sixth aspect of the embodiments of the present disclosure, wherein the computer-readable storage medium is configured to store a computer program, and the computer program causes a computer to execute some of all of the steps described in any method according to the first aspect and the third aspect of the embodiments of the present disclosure.

In the embodiments of the present disclosure, a first image is processed to obtain prediction results of a plurality of pixels in the first image, wherein the prediction results include semantic prediction results and center relative position prediction results, wherein the semantic prediction results indicate that the pixels are located in an instance region or a background region, and the center relative position prediction results indicate relative positions between the pixels and an instance center; and an instance segmentation result of the first image is determined based on the semantic prediction result and the center relative position prediction result of each of the plurality of pixels. Thus, instance segmentation in image processing has the advantages of high speed and high accuracy.

### BRIEF DESCRIPTION OF THE DRAWINGS

FIG. 1 is a schematic flowchart of an image processing method disclosed in embodiments of the present disclosure.

FIG. 2 is a schematic flowchart of another image processing method disclosed in embodiments of the present disclosure.

FIG. 3 is a schematic diagram of a cell instance segmentation result disclosed in embodiments of the present disclosure.

FIG. 4 is a schematic structural diagram of an electronic device disclosed in embodiments of the present disclosure.

FIG. 5 is a schematic flowchart of yet another image processing method disclosed in embodiments of the present disclosure.

FIG. 6 is a schematic flowchart of still another image processing method disclosed in embodiments of the present disclosure.

FIG. 7 is a schematic diagram of an image representation of cell instance segmentation disclosed in embodiments of the present disclosure.

FIG. 8 is a schematic structural diagram of another electronic device disclosed in embodiments of the present disclosure.

FIG. 9 is a schematic structural diagram of yet another electronic device disclosed in embodiments of the present disclosure.

### DETAILED DESCRIPTION

Terms “first”, “second”, or the like in the description, claims, and the drawings in the present disclosure are used for distinguishing different objects, rather than describing specific sequences. In addition, terms “include” and “have” and any variations thereof are intended to cover non-exclusive inclusion. For example, the process, method, system, product, or device including a series of steps or units is not limited to the listed steps or units, but optionally further includes steps or units that are not listed or optionally further includes other steps or units that are inherent in the process, method, product, or device.

Reference in the text to “an embodiment” means that a particular feature, structure, or characteristic described in connection with the embodiment may be included in at least one embodiment of the present disclosure. The appearances of the phrase in various places in the description are not necessarily all referring to the same embodiment, nor are they independent or alternative embodiments that are mutually exclusive with other embodiments. It is explicitly and implicitly understood by a person skilled in the art that the embodiments described herein may be combined with other embodiments.

The electronic device involved in the embodiments of the present disclosure may allow access by multiple other terminal devices. The electronic device includes a terminal device. The terminal device includes, but is not limited to, portable devices such as a mobile phone, a laptop computer, or a tablet computer having a touch-sensitive surface (e.g., a touch screen display and/or a touch panel). It should also be understood that, in some embodiments, the terminal device is not a portable communication device, but a desktop computer having a touch-sensitive surface (e.g., a touch screen display and/or a touch panel).

The concept of deep learning stems from the study of artificial neural networks. A multi-layer perceptron having multiple hidden layers is a deep learning structure. By combining low-level features to form more abstract high-level representations of attribute categories or features, deep learning can discover the distributed feature representations of data.

Deep learning is a method based on learning representations of data in machine learning. An observation (e.g., an image) can be represented in many ways such as a vector of intensity values per pixel, or in a more abstract way as a set of edges, regions of particular shape, or the like. It is easier to learn tasks from instances using some specific representation methods (for example, face recognition or facial expression recognition). The benefit of deep learning is to replace handcrafted features with efficient algorithms for unsupervised or semi-supervised feature learning and hierarchical feature extraction. Deep learning is one new field in machine learning research. Its motivation lies in establishing and simulating the neural network for human brain analysis and learning. It mimics the mechanism of human brain to interpret data such as images, sounds, and text.

Like machine learning methods, in-depth machine learning methods also have supervised learning and unsupervised learning. The learning models established under different learning frameworks are very different. For example, a Convolutional Neural Network (CNN) is a deep machine learning model under supervised learning, and may also be called a network structure model based on deep learning. A Deep Belief Net (DBN) is a machine learning model under unsupervised learning.

The embodiments of the present disclosure are described in detail below. It should be understood that the embodiments of the present disclosure may be applied to cell nucleus segmentation of an image or segmentation of other instances having a closed structure, which is not limited in the embodiments of the present disclosure.

Referring to FIG. 1, FIG. 1 is a schematic flowchart of an image processing method disclosed in embodiments of the present disclosure. As shown in FIG. 1, the image processing method includes the following steps.

At step 101, a first image is processed to obtain prediction results of a plurality of pixels in the first image. The prediction results include semantic prediction results and center relative position prediction results. The semantic prediction results indicate that the pixels are located in an instance region or a background region, and the center relative position prediction results indicate relative positions between the pixels and an instance center.

In step 101, the plurality of pixels may be all or some of the pixels in the first image, which is not limited in the embodiments of the present disclosure. The first image may include a pathological image, such as a cell nucleus image, obtained through various image acquisition devices (such as a microscope). The embodiments of the present disclosure do not limit the manner of obtaining the first image and the specific implementation of the instance.

In the embodiments of the present disclosure, the first image may be processed in various modes. For example, the first image is processed using an instance segmentation algorithm, or, the first image is input to a neural network for processing to output prediction results of a plurality of pixels in the first image, which is not limited in the embodiments of the present disclosure.

In one example, prediction results of a plurality of pixels in the first image are obtained through a deep learning-based neural network, such as Deep Layer Aggregation (DLANet). However, the embodiments of the present disclosure do not limit the specific implementation of the neural network. DLANet augments a standard architecture with deeper aggregation to better fuse information across layers. Deep layer aggregation merges feature hierarchies in an iterative and hierarchical manner, making the network have higher accuracy and fewer parameters. A tree structure is used to replace the previous linear structure, thereby achieving logarithmic level compression rather than linear compression of gradient return length of the network. In this way, a learned feature is more descriptive and can effectively improve the prediction accuracy of the above numerical indicators.

The first image may be subjected to semantic segmentation processing to obtain semantic prediction results of a plurality of pixels in the first image, and an instance segmentation result of the first image may be determined based on the semantic prediction results of the plurality of pixels. The semantic segmentation processing is used for grouping (segmentation) of the pixels in the first image according to different semantic meanings. For example, it can be determined whether each of the plurality of pixels included in the first image relates to an instance or a background, i.e., is located in the instance region or the background region.

Pixel-level semantic segmentation can classify each pixel in an image into a corresponding class, that is, to achieve pixel-level classification; and a specific object of a class is an instance. Instance segmentation not only needs to perform pixel-level classification, but also needs to distinguish different instances based on a specific class. For example, there are three cell nuclei 1, 2, and 3 in the first image, the semantic segmentation results are all cell nuclei, but the instance segmentation results are different objects.

In the embodiments of the present disclosure, independent instance judgment may be performed on each pixel in the first image to determine a semantic segmentation class and an instance ID of the pixel. For example, if there are three cell nuclei in an image, the semantic segmentation class of each cell nucleus is 1, but the IDs of different cell nuclei are 1, 2, and 3 respectively, and different cell nuclei can be distinguished by the cell nucleus IDs.

The semantic prediction result of a pixel may indicate that the pixel is located in the instance region or the background region. That is, the semantic prediction result of a pixel indicates that the pixel relates to an instance or a background.

The instance region may be understood as a region wherein an instance is located, and the background region is a region other than the instance in the image. For example, assuming that the first image is a cell image, the semantic prediction result of a pixel may include indication information for indicating whether the pixel is in a cell nucleus region or a background region in the cell image. In the embodiments of the present disclosure, there are various ways to indicate whether a pixel is in an instance region or a background region. In some possible implementations, the semantic prediction result of a pixel may be one of two preset values, and the two preset values respectively correspond to an instance region and a background region. For example, the semantic prediction result of a pixel is 0 or a positive integer (such as 1). 0 represents a background region, and the positive integer (such as 1) represents an instance region, but the embodiments of the present disclosure are not limited thereto.

The semantic prediction result may be a binarization result. In this case, the first image may be processed to obtain an instance region prediction probability of each of the plurality of pixels, wherein the instance region prediction probability indicates a probability of the pixel being located in the instance region. Then, binarization processing is performed on the instance region prediction probability of each of the plurality of pixels based on a second threshold to obtain a semantic prediction result of each of the plurality of pixels.

In one example, the second threshold for the binarization processing is 0.5. In this case, a pixel having an instance region prediction probability greater than or equal to 0.5 is determined as a pixel located in the instance region, and a pixel having an instance region prediction probability less than 0.5 is determined as a pixel located in the background region. Correspondingly, the semantic prediction result of a pixel having an instance region prediction probability greater than or equal to 0.5 is determined as 1, and the semantic prediction result of a pixel having an instance region prediction probability less than 0.5 is determined as 0, but the embodiments of the present disclosure are not limited thereto.

The prediction result of a pixel may include a center relative position prediction result of the pixel, which is used for indicating the relative position between the pixel and an instance center to which the pixel belongs. In one example, the center relative position prediction result of a pixel includes a prediction result of a center vector of the pixel. For example, the center relative position prediction result of the pixel is expressed as a vector (x, y), which respectively represents differences between the coordinate of the pixel and the coordinate of the instance center on the horizontal axis and the vertical axis. The center relative position prediction result of a pixel may also achieved by other ways, which is not limited in the embodiments of the present disclosure.

An instance center prediction position of a pixel, i.e., a predicted position of the center of an instance to which the pixel belongs, may be determined based on the center relative position prediction result of the pixel and position information of the pixel, and the instance to which the pixel belongs may be determined based on the instance center prediction position of the pixel. However, this is not limited in the embodiments of the present disclosure.

In one example, position information of at least one instance center in the first image is determined based on the processing of the first image, and an instance to which a pixel belongs is determined based on an instance center prediction result of the pixel and the position information of the at least one instance center.

In another example, a small region to which an instance center belongs is defined as an instance center region. For example, an instance center region is a region within an instance region and smaller than the instance region, and the geometric center of the instance center region overlaps or is adjacent to the geometric center of the instance region, for example, the center of the instance center region is the instance center. The instance center region may be circular, oval, or other shapes. The instance center region may be configured as required. The embodiments of the present disclosure do not limit the specific implementation of the instance center region.

In this case, at least one instance center region in the first image may be determined, and an instance to which a pixel belongs may be determined based on the position relationship between the instance center prediction position of the pixel and the at least one instance center region. However, the embodiments of the present disclosure do not limit the specific implementation.

The prediction result of a pixel may further include a center region prediction result of the pixel, indicating whether the pixel is located in an instance center region. Correspondingly, the at least one instance center region of the first image may be determined based on the center region prediction result of each of the plurality of pixels.

In one example, the first image is processed by a neural network to obtain a center region prediction result of each of a plurality of pixels included in the first image.

The neural network may be obtained by training through a supervised training mode. A sample image used in the training process may be labeled with instance information, an instance center region may be determined based on the instance information labeled in the sample image, and the determined instance center region is used as a supervision to train the neural network.

An instance center may be determined based on instance information, and a region of a preset size or area containing the instance center may be determined as an instance center region. Erosion processing may also be performed on the sample image to obtain a sample image after erosion processing, and an instance center region may be determined based on the sample image after erosion processing.

Erosion operation of an image means that detection is performed the image using a certain structural element in order to find out a region in the image wherein the structural element can be placed. The image erosion processing mentioned in the embodiments of the present disclosure may include the above erosion operation. The erosion operation is a process in which a structural element is translated and filled in the eroded image. From the erosion result, foreground regions of the image is reduced, the boundaries of regions are blurred, and some smaller isolated foreground region are completely eroded, thereby achieving a filtering effect.

For example, for each instance mask, first a 5×5 convolution kernel is used to perform image erosion processing on the instance mask. Then, the coordinates of a plurality of pixels included in an instance are averaged to obtain an instance center position, a maximum distance between all the pixels in the instance and the instance center position is determined, and a pixel having a distance from the instance center position less than 30% of the maximum distance is determined as a pixel of an instance center region, to obtain the instance center region. In this way, after the instance mask in the sample image is reduced by one circle, image binarization processing is performed to obtain a binary image mask with the center region predicted.

In addition, based on the coordinates of pixels included in the instance labeled in the sample image and the instance center position, center relative position information of the pixels, i.e., relative position information between the pixels and the instance center, may be obtained, for example, vectors from the pixels to the instance center; and the neural network is trained by using the relative position information as supervision. However, the embodiments of the present disclosure are not limited thereto.

In the embodiments of the present disclosure, the first image is processed to obtain a center region prediction result of each of a plurality of pixels included in the first image. In some possible implementation, the first image is processed to obtain a center region prediction probability of each of the plurality of pixels included in the first image; and binarization processing is performed on the center region prediction probabilities of the plurality of pixels based on a first threshold to obtain the center region prediction result of each of the plurality of pixels.

The center region prediction probability of the pixel may refer to a probability of the pixel being located in the instance center region. A pixel that is not located in the instance center region may be a pixel in the background region or a pixel in the instance region.

In the embodiments of the present disclosure, the binarization processing may be binarization processing with a fixed threshold or binarization processing with an adaptive threshold. For example, a twin peaks method, a P parameter method, an iterative method, and an OTSU method. The embodiments of the present disclosure do not limit the specific implementation of the binarization processing. The first threshold or the second threshold for the binarization processing may be preset or determined according to actual conditions, which is not limited in the embodiments of the present disclosure.

A center region prediction result of a pixel may be obtained by determining the magnitude relationship between a center region prediction probability of the pixel and the first threshold. For example, the first threshold is 0.5. In this case, a pixel having a center region prediction probability greater than or equal to 0.5 may be determined as a pixel located in the instance center region, and a pixel having a center region prediction probability less than 0.5 may be determined as a pixel that is not located in the instance center region, so as to obtain the center region prediction result of each pixel. For example, the center region prediction result of a pixel having a center region prediction probability greater than or equal to 0.5 is determined as 1, and the center region prediction result of a pixel having a center region prediction probability less than 0.5 is determined as 0, but the embodiments of the present disclosure are not limited thereto.

After the prediction results are obtained, step 102 may be performed.

At step 102, an instance segmentation result of the first image is determined based on the semantic prediction result and the center relative position prediction result of each of the plurality of pixels.

In step 101, after obtaining the semantic prediction results and the center relative position prediction results, at least one pixel located in the instance region and relative position information between the at least one pixel and the instance center to which it belongs may be determined. In some possible implementations, at least one first pixel located in the instance region is determined from the plurality of pixels based on the semantic prediction result of each of the plurality of pixels; and an instance to which the first pixel belongs is determined based on the center relative position prediction result of the first pixel.

At least one first pixel located in the instance region may be determined according to the semantic prediction result of each of the plurality of pixels. Specifically, a pixel, in the plurality of pixels, having a semantic prediction result indicating that the pixel is located in the instance region is determined as a first pixel.

For a pixel located in the instance region (i.e., the first pixel), an instance to which the pixel belongs may be determined according to the center relative position prediction result of the pixel. The instance segmentation result of the first image includes pixels included in each of the at least one instance, in other words, the instance to which each pixel located in the instance region belongs. Different instances may be distinguished by different instance identifications or numbers (for example, instance IDs). The instance ID may be an integer greater than 0. For example, the instance ID of instance a is 1, the instance ID of instance b is 2, and the instance ID corresponding to the background is 0. An instance identification corresponding to each of the plurality of pixels included in the first image may be obtained, or an instance identification of each first pixel in the first image may be obtained, that is, a pixel located in the background region does not have a corresponding instance identification. This is not limited in the embodiments of the present disclosure.

For a pixel in cell instance segmentation, if its semantic prediction result is a cell and a center vector representing a center relative position prediction result of the pixel directs to a certain center region, then the pixel is assigned to a cell nucleus region (a cell nucleus semantic region) of the cell. All the pixels are assigned according to the above step, and a cell segmentation result may be obtained.

Cell nucleus segmentation in a digital microscope can extract a high-quality morphological feature of a cell nucleus, or execute computational pathological analysis of the cell nucleus. The information is an important basis for determining, for example, the grade of cancer, and the effectiveness of a medication. In the past, the Otsu algorithm and the watershed threshold algorithm were commonly used to solve the problem of cell nucleus instance segmentation. However, due to the diversity of morphological features of cell nuclei, the above method is not effective. Instance segmentation may depend on a Convolutional Neural Network (CNN). There are mainly target instance segmentation frameworks based on Mask Regions with CNN features (MaskRCNN) and Fully Convolutional Network (FCN). However, the disadvantages of MaskRCN are that there are many hyperparameters, a person needs to have a great number of professional knowledge to get better results for specific problems, and the method runs slowly. FCN requires special image post-processing to separate cells that are adhered into multiple instances, which also requires a great number of professional knowledge from a practitioner.

In the embodiments of the present disclosure, a center vector representing a position relationship of a pixel with respect to the center of an instance to which the pixel belongs is used for modeling, and thus, instance segmentation in image processing has the advantages of high speed and high accuracy. For the problem of cell segmentation, the FCN shrinks some instances into a boundary class, and then corrects the prediction of an instance to which the boundary belongs using a targeted post-processing algorithm. In contrast, center vector modeling can more accurately predict the boundary state of a cell nucleus based on data, without the need for a complicated professional post-processing algorithm. The MaskRCNN first captures the image of each independent instance through a rectangle, and then performs two-class prediction on cells and a background. Because cells appear as multiple irregular ovals gathered together, one instance is located at the center after the capture by a rectangle, and the other instances are still partially located at the edge, which is not conducive to subsequent two-class segmentation. In contrast, center vector modeling does not involve such a problem, and can obtain relatively accurate prediction for the cell nucleus boundary, thereby improving the overall prediction accuracy.

The embodiments of the present disclosure may be applied to clinical auxiliary diagnosis. After a doctor obtains a digital scanned image of a patient's organ and tissue section, the doctor may input the image into the flow in the embodiments of the present disclosure to obtain a pixel mask of each independent cell nucleus. Then, the doctor may calculate the cell density and cell morphological features of the organ based on the pixel mask of each independent cell nucleus of the organ, to obtain a more accurate medical judgment.

In the embodiments of the present disclosure, an instance segmentation result of a first image is determined based on a semantic prediction result and a center relative position prediction result of each of the plurality of pixels included in the first image, and thus, instance segmentation in image processing has the advantages of high speed and high accuracy.

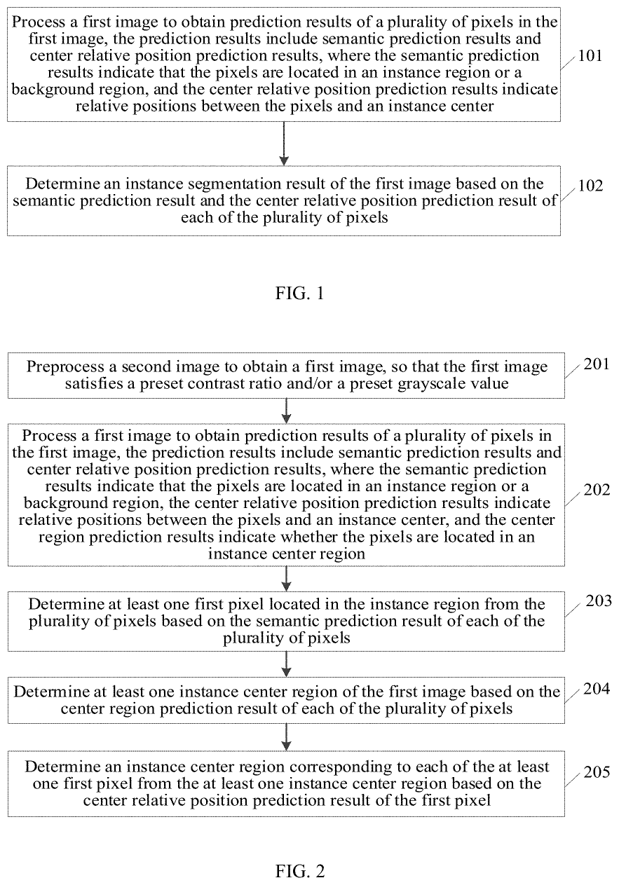

Referring to FIG. 2, FIG. 2 is a schematic flowchart of another image processing method disclosed in embodiments of the present disclosure, and is further optimized based on FIG. 1. The subject performing the steps in the embodiments of the present disclosure may be the electronic device mentioned above. As shown in FIG. 2, the image processing method includes the following steps.

At step 201, a second image is preprocessed to obtain a first image, so that the first image satisfies a preset contrast ratio and/or a preset grayscale value.

The second image mentioned in the embodiments of the present disclosure may be a multi-modal pathological image obtained through various image acquisition devices (such as a microscope). The “multi-modal” may be understood as that the image types may be diverse, the features such as image size, color, and resolution may be different, and the presented image styles are different, that is, the number of the second images may be one or more. In the process of making pathological sections and imaging, due to different types of tissue, acquisition approaches, imaging devices and other factors, the obtained pathological image data usually varies greatly. For example, the resolution of pathological images acquired by different microscopes varies greatly. A light microscope can obtain a color image of pathological tissue (having low resolution), while an electron microscope can usually only acquire a grayscale image (but having high resolution). However, a clinically available pathological system usually needs to analyze different types of pathological tissue acquired by different imaging devices.

In a data set containing the second image, images of different patients, different organs, and different staining methods are complex and diverse. Therefore, the diversity of the second image may be reduced first through step 201.

The subject performing the steps in the embodiments of the present disclosure may be the electronic device mentioned above. The electronic device may store the preset contrast ratio and/or the preset grayscale value, convert the second image into a first image that satisfies the preset contrast ratio and/or the preset grayscale value, and then execute step 202.

The contrast ratio mentioned in the embodiments of the present disclosure refers to measurement of different brightness levels between the brightest white and the darkest black in light and dark regions in an image, the larger the difference range, the larger the contrast, and the smaller the difference range, the smaller the contrast.

Because the colors and brightness of points of a scene are different, points on a captured black-and-white photograph or a black-and-white image reproduced by a television receiver show different shades of gray. The shades of gray between white and black are divided into several levels according to a logarithmic relationship, called “grayscale levels”. Grayscale levels generally ranges from 0 to 255, wherein white is 255 and black is 0. Therefore, a black-and-white image is also called a grayscale image, which can be widely used in the fields of medicine and image recognition.

The preprocessing may also make parameters such as the size, resolution, and format of the second image uniform. For example, the second image may be cropped to obtain a first image of a preset image size, for example, a first image of a uniform size of 256*256. The electronic device may further store a preset image size and/or a preset image format, and may obtain a first image that satisfies the preset image size and/or the preset image format by conversion during preprocessing.

The electronic device may make multi-modal pathological images of different pathological tissue acquired by different imaging devices uniform by means of technologies such as image super resolution and image conversion, so that the images can be used as inputs in the image processing flow in the embodiments of the present disclosure. This step may also be called an image normalization process. Conversion to images of a uniform style facilitates subsequent uniform processing of the images.

Image super resolution technology is a technology that uses an image processing method to convert an existing Low-Resolution (LR) image into a High-Resolution (HR) image by means of a software algorithm (emphasizing that the imaging hardware device is not changed), and can be divided into super resolution restoration and Super Resolution Image Reconstruction (SRIR). At present, image super resolution research may be divided into three main categories: interpolation-based, reconstruction-based, and learning-based methods. The core concept of super resolution reconstruction is to exchange time bandwidth (obtaining a multi-frame image sequence of the same scene) for spatial resolution to achieve the conversion from temporal resolution to spatial resolution. By the above preprocessing, an HR first image can be obtained, which is very helpful for a doctor to make a correct diagnosis. If an HR image can be provided, the performance of pattern recognition in computer vision will also be greatly improved.

At step 202, the first image is processed to obtain prediction results of a plurality of pixels in the first image. The prediction results include semantic prediction results, center relative position prediction results, and center region prediction results. The semantic prediction results indicate that the pixels are located in an instance region or a background region, the center relative position prediction results indicate relative positions between the pixels and an instance center, and the center region prediction results indicate whether the pixels are located in an instance center region.

For step 202, reference may be made to the detailed description in step 101 of the embodiment shown in FIG. 1, and details are not described herein again.

At step 203, at least one first pixel located in the instance region is determined from the plurality of pixels based on the semantic prediction result of each of the plurality of pixels.

It can be determined based on the semantic prediction result of each of the plurality of pixels whether the pixel is located in the instance region or the background region, so that at least one first pixel located in the instance region can be determined from the plurality of pixels.

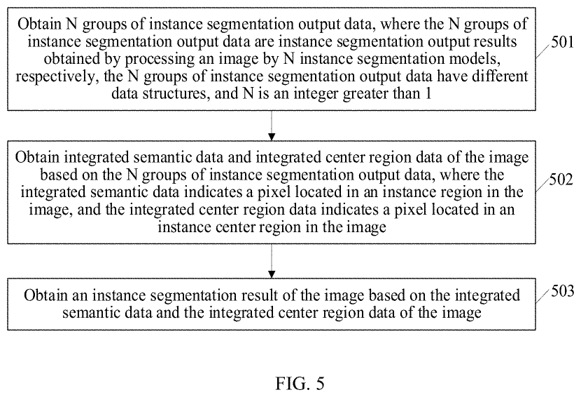

For the instance region, reference may be made to the detailed description in the embodiment shown in FIG. 5, and details are not described herein again.

At step 204, at least one instance center region of the first image is determined based on the center region prediction result of each of the plurality of pixels.

For the instance center region, reference may be made to the detailed description in the embodiment shown in FIG. 1, and details are not described herein again.

For the center relative position prediction result, reference may be made to the detailed description in the embodiment shown in FIG. 1, and details are not described herein again.

In the embodiments of the present disclosure, the center region prediction result may indicate whether a pixel is located in an instance center region, and thus a pixel located in an instance region may be determined by referring to the center region prediction result. Pixels located in an instance center region can constitute the instance center region, thereby determining at least one instance center region.

Connected component search processing may be performed on the first image based on the center region prediction result of each of the plurality of pixels to obtain the at least one instance center region.

A connected component generally refers to an image region (Blob) consisting of adjacent foreground pixels having the same pixel value in an image. The above connected component search may be understood as connected component analysis (connected component labeling), and is used for finding out and labeling connected components in the image.

Connected component analysis is a common and basic method in many application fields of the International Conference on Computer Vision and Pattern Recognition (CVPR) and image analysis processing. For example, character segmentation extraction in Optical Character Recognition (OCR) (license plate recognition, text recognition, subtitle recognition, or the like), segmentation and extraction of a moving foreground target in visual tracking (pedestrian intrusion detection, abandoned object detection, vision-based vehicle detection and tracking, or the like), medical image processing (extraction of a target region of interest), or the like. That is to say, the connected component analysis method can be used in any application scenario wherein the foreground target needs to be extracted for subsequent processing. Usually, an object of connected component analysis processing is an image after binarization (a binary image).

The condition enabling a path to exist for a set S is that a certain arrangement of pixels of the path makes adjacent pixels satisfy a certain adjacency relationship. For example, assuming that there are pixels A1, A2, A3, . . . , An between point p and point q, and that adjacent pixels satisfy certain adjacency, then there is a path between p and q. If the path is connected end to end, it is called a closed path. There is only one path for a point p in the set S, and it is called a connected component. If S has only one connected component, it is called one connected set.

For R as one image subset, if R is connected, then R is called one region. For all K regions that are not connected, the union Rk thereof constitutes a foreground of the image, and the complement of Rk is called a background.

Connected component search processing is performed on the first image based on the center region prediction result of each pixel to obtain the at least one instance center region, and then the process proceeds to step 205.

Specifically, for the first image after binarization processing, a connected component with a center region being 1 may be searched for to determine an instance center region, and one independent ID is assigned to each connected component.

For cell segmentation, based on the coordinate of a pixel in a cell nucleus and a center vector representing a position relationship between the pixel and the center of an instance to which the pixel belongs, whether a position to which the center vector points is in the center region may be determined. If the position to which the center vector of the pixel points is in the center region, a cell nucleus ID is assigned to the pixel; otherwise, it indicates that the pixel does not belong to any cell nucleus and proximity-based assignment may be performed.

Connected component search processing may be performed on the first image by a random walk algorithm to obtain at least one instance center region.

A random walk is one in which future steps or directions cannot be predicted on the basis of past history. The core concept of random walk is that the conserved quantity carried by any random walker corresponds to one diffusion transport law, and random walk is close to Brownian motion, and is an ideal mathematical state of Brownian motion. The basic concept of random walk for image processing in the embodiments of the present disclosure is to treat an image as a connected weighted undirected graph formed of fixed vertices and edges, start a random walk from an unlabeled vertex, wherein the probabilities of reaching various types of labeled vertices for the first time represent the possibilities of the unlabeled point belonging to labeled classes, and assign the label of a class with the greatest probability to the unlabeled vertex to complete segmentation. The random walk algorithm above can be used to assign a pixel that does not belong to any center region to obtain the at least one instance center region.

A pixel connection map may be output through a deep hierarchical aggregation network model, and an instance segmentation result may be obtained after the connected component search processing. A random color may be given to each instance region in the above instance segmentation result to facilitate visualization.

Steps 203 and 204 may also be performed in no particular sequence; after determining the at least one instance center region, step 205 may be performed.

At step 205, an instance center region corresponding to each first pixel is determined from the at least one instance center region based on the center relative position prediction result of the first pixel.

Specifically, a center prediction position of the first pixel may be determined based on position information of the first pixel and the center relative position prediction result of the first pixel.

In step 202, position information of a pixel, which may be specifically the coordinate of the pixel, may be obtained. Moreover, a center prediction position of the first pixel may be determined according to the coordinate of the first pixel and the center relative position prediction result of the first pixel. The center prediction position may indicate a predicted center position of an instance center region to which the first pixel belongs.

An instance center region corresponding to the first pixel may be determined from the at least one instance center region based on the center prediction position of the first pixel and position information of the at least one instance center region.

In step 204, position information of an instance center region may be obtained, or it may be represented by a coordinate. Further, whether the center prediction position of the first pixel belongs to the at least one instance center region may be determined based on the center prediction position of the first pixel and the position information of the at least one instance center region, so as to determine an instance center region corresponding to the first pixel from the at least one instance center region.

Specifically, in response to the center prediction position of the first pixel belonging to a first instance center region in the at least one instance center region, the first instance center region may be determined as an instance center region corresponding to the first pixel, and the pixel may be assigned to the instance center region.

In response to the center prediction position of the first pixel not belonging to any instance center region in the at least one instance center region, proximity-based assignment is performed, i.e., an instance center region closest to the center prediction position of the first pixel in the at least one instance center region is determined as an instance center region corresponding to the first pixel.

In the embodiments of the present disclosure, the output in step 202 may have three branches: the first is a semantic judgment branch, which includes 2 channels to give output about whether each pixel is located in an instance region or a background region; the second is a center region branch, which includes 2 channels to give output about whether each pixel is located in a center region or a non-center region; and the third is a center vector branch, which includes 2 channels to output the relative position between each pixel and an instance center, specifically including horizontal and vertical components of a vector of the pixel pointing to the geometric center of an instance to which the pixel belongs.

In the embodiments of the present disclosure, the instance segmentation object may be a cell nucleus. In this way, because the center region is a center region of one cell nucleus, the position of the cell nucleus is actually preliminarily determined after the center region is determined, and a number, i.e., the instance ID above, may be assigned to each cell nucleus.

Specifically, supposing that the input second image is a 3-channel image of [height, width, 3], three arrays of [height, width, 2] may be obtained in step 202 in the embodiments of the present disclosure, specifically the semantic prediction probability, the center region prediction probability, and the center relative position prediction result of each pixel. Then, binarization with a threshold of 0.5 may be performed on the center region prediction probability, then a center region of each cell nucleus may be obtained through connected component search processing, and an independent number is assigned to the center region. The number assigned to each cell is the instance ID above, distinguishing different cell nuclei.

For example, assuming that in step 203, the semantic prediction result of one pixel a is determined as a cell nucleus rather than the background (it is determined that the pixel belongs to a cell nucleus semantic region), and a center vector of the pixel a is obtained in step 202, if the center vector of the pixel a points to the first center region of the at least one instance center region obtained in step 204, it indicates that the pixel a has a correspondence with the first center region. Specifically, the pixel a belongs to a cell nucleus A wherein the first center region is located, and the first center region is the center region of the cell nucleus A.

Taking cell segmentation as an example, through the above steps, a cell nucleus and an image background may be segmented, all pixels that belong to the cell nucleus may be assigned, and a cell nucleus to which each pixel belongs, a cell nucleus center region to which the pixel belongs, and a center of the cell nucleus to which the pixel belongs may be determined, thereby achieving more accurate segmentation of a cell and obtaining an accurate instance segmentation result.

In the embodiments of the present disclosure, a center vector is used for modeling, so that accurate prediction may be obtained for the cell nucleus boundary, thereby improving the overall prediction accuracy.

Using the center vector method in the embodiments of the present disclosure, not only a high operation speed and the processing capacity of 3 images per second can be achieved, but also a better result can be achieved by obtaining a certain amount of labeled data and then performing processing in any instance segmentation problem without the need for a great number of domain knowledge of a practitioner.

The embodiments of the present disclosure may be applied to clinical auxiliary diagnosis. For detailed description, reference may be made to the embodiment shown in FIG. 1, and details are not described herein again.

In the embodiments of the present disclosure, a second image is preprocessed to obtain a first image, and an instance center region corresponding to each first pixel located in an instance region in the first image is determined based on the semantic prediction result, the center region prediction result, and the center relative position prediction result of each of a plurality of pixels included in the first image, thereby effectively achieving accurate segmentation of an instance, and bringing the advantages of high speed and high accuracy to instance segmentation in image processing.

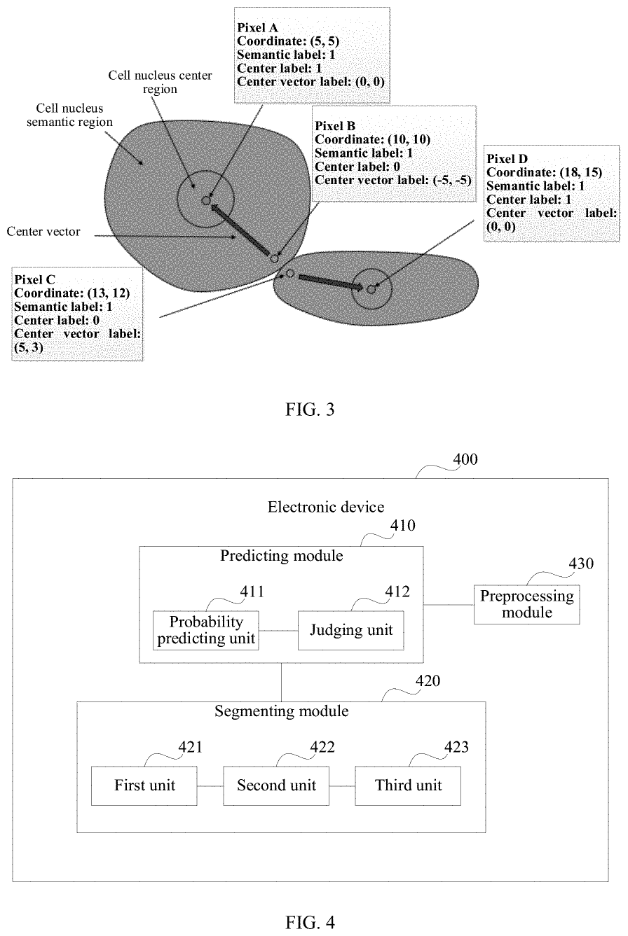

Referring to FIG. 3, FIG. 3 is a schematic diagram of a cell instance segmentation result disclosed in embodiments of the present disclosure. As shown, taking cell instance segmentation as an example, processing by the method in the embodiments of the present disclosure has the characteristics of high speed and high accuracy. Combining FIG. 3 can facilitate a clearer understanding of the methods in the embodiments shown in FIG. 1 and FIG. 2. More accurate prediction indicators may be obtained through a deep hierarchical aggregation network model, and the prediction indicators may be labeled using an existing data set. The semantic prediction results, the center region prediction results, and the center relative position prediction results in the foregoing embodiments embodied in FIG. 3 include semantic labels, center labels, and center vector labels of pixel A, pixel B, pixel C, and pixel D, respectively. As shown, one cell nucleus may include a cell nucleus semantic region and a cell nucleus center region. For a pixel in the drawing, if the semantic label of the pixel is 1, it indicates that the pixel belongs to a cell nucleus, and if the semantic label of the pixel is 0, it indicate that the pixel belongs to an image background; if the center label of the pixel is 1, it indicates that the pixel is the center of the cell nucleus region, and in this case, the center vector label of the pixel is (0,0), which may be used as a reference for other pixels (for example, pixel A and pixel D in the drawing, the determination of pixel A may also represent the determination of one cell nucleus). Each pixel corresponds to one coordinate, and the center vector label is the coordinate of the pixel with respect to a pixel which is the center of the cell nucleus, for example, the center vector label of pixel B with respect to pixel A is (−5, −5), the center vector label of the pixel which is the center is (0,0), such as pixel A and pixel D. In the embodiments of the present disclosure, it can be determined that pixel B belongs to a cell nucleus region to which pixel A belongs, that is, pixel B is assigned to the cell nucleus region to which pixel A belongs, but is not in a cell nucleus center region but in a cell nucleus semantic region. By completing the entire segmentation process similarly, an accurate segmentation result of the cell instance can be obtained.

The above mainly introduces the solution of the embodiments of the present disclosure from the perspective of a method-side execution process. It can be understood that, in order to achieve the above functions, the electronic device includes a hardware structure and/or a software module corresponding to each function. A person skilled in the art should easily learn that, with reference to the units and algorithm steps in the examples described in the embodiments disclosed herein, the present disclosure can be implemented in hardware or a combination of hardware and computer software. Whether a certain function is performed by hardware or computer software-driven hardware depends on the particular applications and design constraint conditions of the technical solutions. For a specific application, the described functions can be implemented by a person skilled in the art using different methods, but this implementation should not be considered to go beyond the scope of the present disclosure.

In the embodiments of the present disclosure, functional units of the electronic device may be divided according to the foregoing method examples. For example, functional units may be divided corresponding to functions, or two or more functions may be integrated into one processing unit. The integrated unit may be implemented in a form of hardware and may also be implemented in a form of a software functional unit. It should be noted that the unit division in the embodiments of the present disclosure is schematic and merely logical function division, and may be actually implemented by other division modes.

Referring to FIG. 4, FIG. 4 is a schematic structural diagram of an electronic device disclosed in embodiments of the present disclosure. As shown in FIG. 4, the electronic device 400 includes a predicting module 410 and a segmenting module 420. The predicting module 410 is configured to process a first image to obtain prediction results of a plurality of pixels in the first image, wherein the prediction results include semantic prediction results and center relative position prediction results, wherein the semantic prediction results indicate that the pixels are located in an instance region or a background region, and the center relative position prediction results indicate relative positions between the pixels and an instance center; and the segmenting module 420 is configured to determine an instance segmentation result of the first image based on the semantic prediction result and the center relative position prediction result of each of the plurality of pixels.

The electronic device 400 may further include a preprocessing module 430, configured to preprocess a second image to obtain the first image, so that the first image satisfies a preset contrast ratio and/or a preset grayscale value.

The segmenting module 420 may include a first unit 421 and a second unit 422, wherein the first unit 421 is configured to determine at least one first pixel located in the instance region from the plurality of pixels based on the semantic prediction result of each of the plurality of pixels; and the second unit 422 is configured to determine an instance to which each first pixel belongs based on the center relative position prediction result of the first pixel.

The prediction results may further include center region prediction results, and the center region prediction results indicate whether the pixels are located in an instance center region. In this case, the segmenting module 420 may further include a third unit 423, configured to determine at least one instance center region of the first image based on the center region prediction result of each of the plurality of pixels; and the second unit 422 is specifically configured to determine an instance center region corresponding to each first pixel based on the center relative position prediction result of the first pixel.

The third unit 423 may be specifically configured to perform connected component search processing on the first image based on the center region prediction result of each of the plurality of pixels to obtain the at least one instance center region.

The second unit 422 may be specifically configured to: determine a center prediction position of the first pixel based on position information of the first pixel and the center relative position prediction result of the first pixel; and determine the instance center region corresponding to the first pixel from the at least one instance center region based on the center prediction position of the first pixel and position information of the at least one instance center region.

The second unit 422 may be specifically configured to: in response to the center prediction position of the first pixel belonging to a first instance center region in the at least one instance center region, determine the first instance center region as the instance center region corresponding to the first pixel.

The second unit 422 may be specifically configured to: in response to the center prediction position of the first pixel not belonging to any instance center region in the at least one instance center region, determine an instance center region closest to the center prediction position of the first pixel in the at least one instance center region as the instance center region corresponding to the first pixel.

The predicting module 410 includes a probability predicting unit 411 and a judging unit 412, wherein the probability predicting unit 411 is configured to process the first image to obtain respective center region prediction probabilities of the plurality of pixels in the first image; and the judging unit 412 is configured to perform binarization processing on the respective center region prediction probabilities of the plurality of pixels based on a first threshold to obtain the center region prediction result of each of the plurality of pixels.

The predicting module 410 may be specifically configured to input the first image to a neural network for processing to output the prediction results of the plurality of pixels in the first image.

In the embodiments of the present disclosure, a center vector is used for modeling, so that accurate prediction may be obtained for the cell nucleus boundary, thereby improving the overall prediction accuracy.

By the electronic device 400 in the embodiments of the present disclosure, the image processing methods in the foregoing embodiments of FIGS. 1 and 2 can be implemented. By instance segmentation using the center vector method, not only a high operation speed and the processing capacity of 3 images per second can be achieved, but also a better result can be achieved by obtaining a certain amount of labeled data and then performing processing in any instance segmentation problem without the need for a great number of domain knowledge of a practitioner.

According to the electronic device 400 shown in FIG. 4, the electronic device 400 may determine an instance segmentation result of a first image based on a semantic prediction result and a center relative position prediction result of each of the plurality of pixels included in the first image, and thus, instance segmentation in image processing has the advantages of high speed and high accuracy.

Referring to FIG. 5, FIG. 5 is a schematic flowchart of an image processing method disclosed in embodiments of the present disclosure. The method may be performed by any electronic device, such as a terminal device, a server, or a processing platform, which is not limited in the embodiments of the present disclosure. As shown in FIG. 5, the image processing includes the following steps.

At step 501, N groups of instance segmentation output data are obtained. The N groups of instance segmentation output data are instance segmentation output results obtained by processing an image by N instance segmentation models, respectively, the N groups of instance segmentation output data have different data structures, and N is an integer greater than 1.

First, the instance segmentation problem in image processing is defined as follows: for an input image, each pixel must be independently determined to determine its semantic class and instance ID. For example, there are three cell nuclei 1, 2, and 3 in an image, the semantic categories thereof are all cell nuclei, but the instance segmentation results are different objects.

For instance segmentation, reference may be made to the detailed description in the embodiment shown in FIG. 1, and details are not described herein again.

Instance segmentation may also be implemented by an instance segmentation algorithm, for example, a machine learning model such as a support vector machine-based instance segmentation algorithm. The embodiments of the present disclosure do not limit the specific implementation of the instance segmentation model.

Different instance segmentation models have their own advantages and disadvantages. The embodiments of the present disclosure integrate the advantages of different single models by integrating multiple instance segmentation models.

Before executing step 501, different instance segmentation models may be used to process the image separately. For example, MaskRCNN and FCN are used to process the image separately to obtain instance segmentation output results. Assuming that there are N instance segmentation models, an instance segmentation result (hereinafter referred to as instance segmentation output data) of each of the N instance segmentation models may be obtained, that is, N groups of instance segmentation output data are obtained. Alternatively, the N groups of instance segmentation output data may be obtained from other devices. The embodiments of the present disclosure do not limit the mode of obtaining the N groups of instance segmentation output data.

Before using an instance segmentation model to process the image, the image may also be subjected to preprocessing, for example, contrast ratio and/or grayscale adjustment, or one or more operations in cropping, horizontal and vertical flipping, rotation, scaling, noise removal, or the like, so that the pre-processed image satisfies the requirements of the instance segmentation model for an input image. This is not limited in the embodiments of the present disclosure.

In the embodiments of the present disclosure, the instance segmentation output data output by the N instance segmentation models may have different data structures or meanings. For example, for the input of one image having the dimension being [height, width, 3], the instance segmentation output data includes [height, width] data. An instance ID which is 0 indicates the background, and different numbers greater than 0 indicate different instances. Suppose that there are 3 instance segmentation models, and different instance segmentation models correspond to different algorithms or neural network structures, wherein the instance segmentation output data of the first instance segmentation model is a three-class probability map of [boundary, target, background]; the instance segmentation output data of the second instance segmentation model is a two-class probability map of [boundary, background] and a two-class map with the dimension being [objective, background]; the instance segmentation output data of the third instance segmentation model is a three-class probability map of [center region, target whole, background], or the like. Different instance segmentation models have data outputs of different meanings. In this case, it is not possible to integrate the outputs of the instance segmentation models by any weighted average algorithm to obtain more stable and more accurate results. According to the method in the embodiments of the present disclosure, cross-instance segmentation model integration may be performed on the basis that the N groups of instance segmentation output data having different data structures.

After obtaining the N groups of instance segmentation output data, step 502 may be performed.

At step 502, integrated semantic data and integrated center region data of the image is obtained based on the N groups of instance segmentation output data. The integrated semantic data indicates a pixel located in an instance region in the image, and the integrated center region data indicates a pixel located in an instance center region in the image.

Specifically, an electronic device may perform conversion processing on the N groups of instance segmentation output data to obtain integrated semantic data and integrated center region data of the image.

The semantic segmentation mentioned in the embodiments of the present disclosure is a basic task in computer vision, and reference may be made to the detailed description in the embodiment shown in FIG. 1. Details are not described herein again.

For pixel-level semantic segmentation, reference may be made to the detailed description in the embodiment shown in FIG. 1, and details are not described herein again.

The instance region may be understood as a region wherein an instance is located in the image, that is, a region other than the background region, and the integrated semantic data may indicate a pixel located in the instance region in the image. For example, for cell nucleus segmentation processing, the integrated semantic data may include a judgment result of a pixel located in a cell nucleus region.

The integrated center region data may indicate a pixel located in an instance center region in the image.

For the instance center region, reference may be made to the detailed description in the embodiment shown in FIG. 1, and details are not described herein again.

Specifically, semantic data and center region data of each of the N instance segmentation models may be first obtained based on the instance segmentation output data of the instance segmentation model, that is, there are a total of N groups of semantic data and N groups of center region data. Then, integration processing is performed based on the semantic data and the center region data of each of the N instance segmentation models to obtain the integrated semantic data and the integrated center region data of the image.

For each of the N instance segmentation models, instance identification information (instance ID) corresponding to each pixel in the instance segmentation model may be determined, and then a semantic prediction value of each pixel in the instance segmentation model is obtained based on the instance identification information corresponding to the pixel in the instance segmentation model. The semantic data of the instance segmentation model includes the semantic prediction value of each of a plurality of pixels in the image.

Binarization is a simple method for image segmentation. Binarization can convert a grayscale image into a binary image. For example, the grayscale of a pixel greater than a certain threshold grayscale value may be set to a maximum grayscale value, and the grayscale of a pixel less than this value may be set to a minimum grayscale value, so as to achieving binarization.

For binarization processing, reference may be made to the detailed description in the embodiment shown in FIG. 1, and details are not described herein again.

In the embodiments of the present disclosure, a first image may be processed to obtain a semantic prediction result of each of the plurality of pixels included in the first image. A semantic prediction result of a pixel may be obtained by determining the magnitude relationship between a semantic prediction value of the pixel and a first threshold. The first threshold may be preset or determined according to actual conditions, which is not limited in the embodiments of the present disclosure.

After the integrated semantic data and the integrated center region data of the image are obtained, step 503 may be performed.

At step 503, an instance segmentation result of the image is obtained based on the integrated semantic data and the integrated center region data of the image.

At least one instance center region of the image may be obtained based on the integrated center region data of the image. Then, an instance to which each of the plurality of pixels in the image belongs may be determined based on the at least one instance center region and the integrated semantic data of the image.

The integrated semantic data indicates at least one pixel located in the instance region in the image. For example, the integrated semantic data may include an integrated semantic value of each of the plurality of pixels in the image, and the integrated semantic value is used to indicate whether the pixel is located in the instance region or to indicate whether the pixel is located in the instance region or the background region. The integrated center region data indicates at least one pixel located in the instance center region in the image. For example, the integrated center region data includes an integrated center region prediction value of each of the plurality of pixels in the image, and the integrated center region prediction value is used to indicate whether the pixel is located in the instance center region.

At least one pixel included in the instance region of the image may be determined through the integrated semantic data, and at least one pixel included in the instance center region of the image may be determined through the integrated center region data. Based on the integrated center region data and the integrated semantic data of the image, an instance to which each of the plurality of pixels in the image belongs may be determined, and an instance segmentation result of the image may be obtained.

By means of the method above, the obtained instance segmentation result integrate the instance segmentation output results of the N instance segmentation models, the advantages of different instance segmentation models are integrated, different instance segmentation models are no longer required to have data outputs with the same meaning, and the accuracy of instance segmentation is improved.

According to the embodiments of the present disclosure, integrated semantic data and integrated center region data of an image are obtained based on N groups of instance segmentation output data obtained by processing the image through N instance segmentation models, and then an instance segmentation result of the image is obtained based on the integrated semantic data and the integrated center region data of the image; thus, complementary advantages of the instance segmentation models can be achieved, the models are no longer required to have data outputs with the same structure or meaning, and higher accuracy can be obtained in an instance segmentation problem.

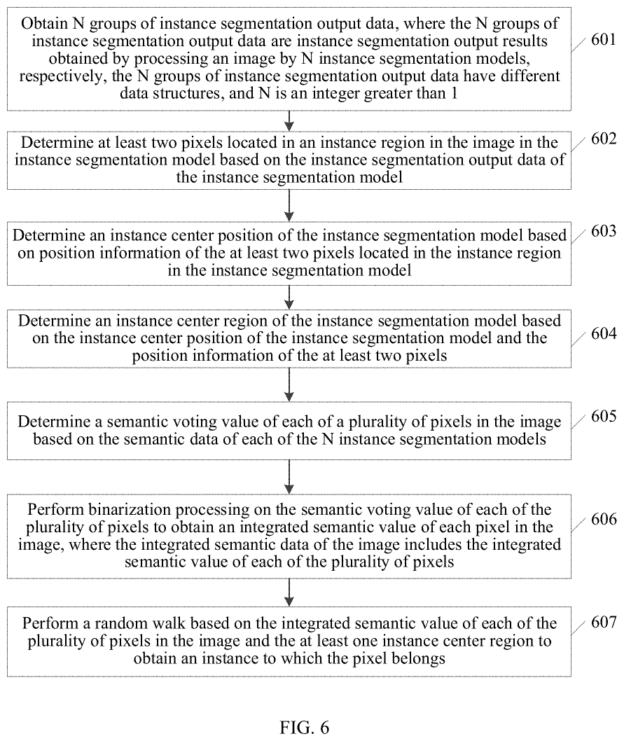

Referring to FIG. 6, FIG. 6 is a schematic flowchart of another image processing method disclosed in embodiments of the present disclosure, and is further optimized based on FIG. 5. The method may be performed by any electronic device, such as a terminal device, a server, or a processing platform, which is not limited in the embodiments of the present disclosure. As shown in FIG. 6, the image processing method includes the following steps.

At step 601, N groups of instance segmentation output data are obtained. The N groups of instance segmentation output data are instance segmentation output results obtained by processing an image by N instance segmentation models, respectively, the N groups of instance segmentation output data have different data structures, and N is an integer greater than 1.

For step 601, reference may be made to the detailed description in step 501 of the embodiment shown in FIG. 5, and details are not described herein again.

At step 602, at least two pixels located in an instance region in the image are determined in each of the instance segmentation models based on the instance segmentation output data of the instance segmentation model.

For the instance center region, reference may be made to the detailed description in the embodiment shown in FIG. 1, and details are not described herein again. The instance segmentation output data may include instance identification information corresponding to each of the at least two pixels located in the instance region in the image, for example, the instance ID is an integer greater than 0, such as 1, 2, or 3, or may be another value. The instance identification information corresponding to a pixel located in a background region may be a preset value, or the pixel located in the background region may not correspond to any instance identification information. In this way, at least two pixels located in an instance region in the image may be determined based on instance identification information corresponding to each of a plurality of pixels in the instance segmentation output data.

The instance segmentation output data may not include instance identification information corresponding to each pixel. In this case, at least two pixels located in an instance region in the image may be obtained by processing the instance segmentation output data, which is not limited in the embodiments of the present disclosure.

After the at least two pixels located in the instance region in the image are determined, step 603 may be performed.

At step 603, an instance center position of the instance segmentation model is determined based on position information of the at least two pixels located in the instance region in the instance segmentation model.

After determining the at least two pixels located in the instance region in the instance segmentation model, position information of the at least two pixels may be obtained. The position information may include coordinates of the pixels in the image, but the embodiments of the present disclosure are not limited thereto.

An instance center position of the instance segmentation model may be determined according to the position information of the at least two pixels. The instance center position is not limited to the geometric center position of an instance, but may be a predicted center position of an instance region, and may be understood as any position in an instance center region.

The average value of the positions of the at least two pixels located in the instance region may be used as the instance center position of the instance segmentation model.

Specifically, the average value of the coordinates of the at least two pixels located in the instance region may be used as the coordinate of the instance center position of the instance segmentation model to determine the instance center position.

At step 604, an instance center region of the instance segmentation model is determined based on the instance center position of the instance segmentation model and the position information of the at least two pixels.

Specifically, a maximum distance between the at least two pixels and the instance center position may be determined based on the instance center position of the instance segmentation model and the position information of the at least two pixels, and then a first threshold may be determined based on the maximum distance. Then, a pixel in the at least two pixels which has a distance from the instance center position less than or equal to the first threshold may be determined as a pixel in the instance center region.

For example, a distance from each pixel to the instance center position (pixel distance) can be calculated based on the instance center position of the instance segmentation model and the position information of the at least two pixels. An algorithm for the first threshold may be configured in advance in the electronic device, for example, the first threshold may be set to 30% of the maximum distance among the pixel distances. After determining the maximum distance among the pixel distances, the first threshold may be calculated. Based on this, pixels having a pixel distance less than the first threshold are retained, and are determined as pixels of the instance center region, that is, the instance center region is determined.

Erosion processing may also be performed on a sample image. For erosion processing, reference may be made to the detailed description in the embodiment shown in FIG. 1, and details are not described herein again.

In addition, for center relative position information of the pixels, reference may be made to the detailed description in the embodiment shown in FIG. 1, and details are not described herein again.

At step 605, a semantic voting value of each of the plurality of pixels in the image is determined based on the semantic data of each of the N instance segmentation models.

The electronic device may perform semantic voting on each of the plurality of pixels based on the semantic data of each of the N instance segmentation models, and determine a semantic voting value of each of the plurality of pixels in the image. For example, the semantic data of the instance segmentation model may be processed by sliding window-based voting to determine the semantic voting value of each pixel, and then step 606 may be performed.

At step 606, binarization processing is performed on the semantic voting value of each of the plurality of pixels to obtain an integrated semantic value of the pixel in the image. The integrated semantic data of the image includes the integrated semantic value of each of the plurality of pixels.

Binarization processing may be performed on the semantic voting values from the N instance segmentation models of each pixel to obtain an integrated semantic value of the pixel in the image. It may be understood that semantic masks obtained by different instance segmentation models are added to obtain an integrated semantic mask.

Specifically, a second threshold may be determined based on the number N of the multiple instance segmentation models; and binarization processing is performed on the semantic voting value of each of the plurality of pixels based on the second threshold to obtain the integrated semantic value of each pixel in the image.

Because the integrated semantic value of each of the plurality of pixels may be taken as the number of the instance segmentation models, the second threshold may be determined based on the number N of the multiple instance segmentation models. For example, the second threshold may be a round-up result of N/2.

The integrated semantic value of each pixel in the image may be obtained by using the second threshold as a judgment basis for the binarization processing in this step. The electronic device may store a calculation method for the second threshold, for example, a preset pixel threshold is specified as N/2, and if N/2 is not an integer, it is rounded up. For example, if 4 groups of instance segmentation output data are obtained by 4 instance segmentation model, then N=4, and 4/2=2. In this case, the second threshold is 2. Correspondingly, when comparing the semantic voting value with the second threshold, the truncation of the semantic voting value greater than or equal to 2 is 1, and the truncation of the semantic voting value less than 2 is 0. Thus, the integrated semantic value of each pixel in the image is obtained, and in this case, the output data may specifically be an integrated semantic binary map. The integrated semantic value may be understood as the semantic segmentation result of each pixel, and an instance to which the pixel belongs may be determined on this basis to implement instance segmentation.

At step 607, a random walk is performed based on the integrated semantic value of each of the plurality of pixels in the image and the at least one instance center region to obtain an instance to which the pixel belongs.

For random walk, reference may be made to the detailed description in the embodiment shown in FIG. 1, and details are not described herein again.

Based on the integrated semantic value of each of the plurality of pixels in the image and the at least one instance center region, a random walk is used to determine the assignment of the pixel according to the integrated semantic value of the pixel, so as to obtain an instance to which the pixel belongs. For example, an instance corresponding to an instance center region closest to a pixel may be determined as the instance to which the pixel belongs. In the embodiments of the present disclosure, by obtaining a final integrated semantic map and a final integrated center region map, the pixel assignment of an instance may be determined in combination with a specific implementation of the connected component search and random walk (proximity-based assignment) to obtain a final instance segmentation result.

By means of the method above, the obtained instance segmentation result integrate the instance segmentation output results of the N instance segmentation models, the advantages of the instance segmentation models are integrated, different instance segmentation models are no longer required to have continuous probability map outputs with the same meaning, and the accuracy of instance segmentation is improved.

The method in the embodiments of the present disclosure is applicable to any instance segmentation problem. For example, it may be applied to clinical auxiliary diagnosis. Reference may be made to the detailed description in the embodiment shown in FIG. 1, and details are not described herein again. For another example, it may be applied around a hive, after a keeper obtains an image of dense bees flying around the hive, this algorithm may be used by the keeper to obtain an instance pixel mask for each independent bee, so that macro bee counting, behavior pattern calculation, or the like can be performed, thereby having great practical value.

In a specific application of the embodiments of the present disclosure, a UNet model may be applied for a bottom-up method. UNet is first developed for semantic segmentation and effectively fuses information from multiple scales. A MaskR-CNN model may be applied for a top-down method. MaskR-CNN extends faster R-CNN by adding a head to a segmentation task. In addition, the proposed MaskR-CNN can align a tracking feature with the input, avoiding any quantization of bilinear interpolation. Alignment is important for a pixel-level task, such as an instance segmentation task.

The network structure of the UNet model consists of a contracting path and an expanding path. The contracting path is used for obtaining context information, the expanding path is used for precise localization, and the two paths are symmetrical to each other. The network can be trained end-to-end from very few images, and performs better than a previous best method (a sliding window convolutional network) on segmenting a cell structure such as a neuron in an electron microscope. In addition, it runs very fast.

UNet and Mask R-CNN models may be used to perform segmentation prediction on an instance to obtain a semantic mask of each instance segmentation model, and the semantic masks are integrated by pixel voting. Then, a center mask of each instance segmentation model is calculated through erosion processing, and the center masks are integrated. Finally, an instance segmentation result is obtained from the integrated semantic mask and the integrated center mask by the random walk algorithm.

The result above may be evaluated by cross-validation. Cross-validation is mainly used in a modeling application. In given modeling samples, most of the samples are taken out to establish a model, a small number of the samples are left for prediction using the model just established, prediction errors of the small number of samples are calculated, and their sum of squares is recorded. In the embodiments of the present disclosure, 3-fold cross-validation may be used for evaluation; three UNet models with AJI(5) scores of 0.605, 0.599, and 0.589 are combined with one MaskR-CNN model with an AJI(5) score of 0.565, and a result obtained using the method of the embodiments of the present disclosure has a final AJI(5) score of 0.616. It can be seen that the image processing method in the present disclosure has obvious advantages.

In the embodiments of the present disclosure, based on instance segmentation output data obtained by processing an image using N instance segmentation models, instance center regions of the instance segmentation models are determined, and a random walk is performed based on an integrated semantic value of each of a plurality of pixels of the image and at least one instance center region to obtain an instance to which the pixel belongs; thus, complementary advantages of the instance segmentation models can be achieved, the models are no longer required to have data outputs with the same structure or meaning, and higher accuracy can be obtained in an instance segmentation problem.

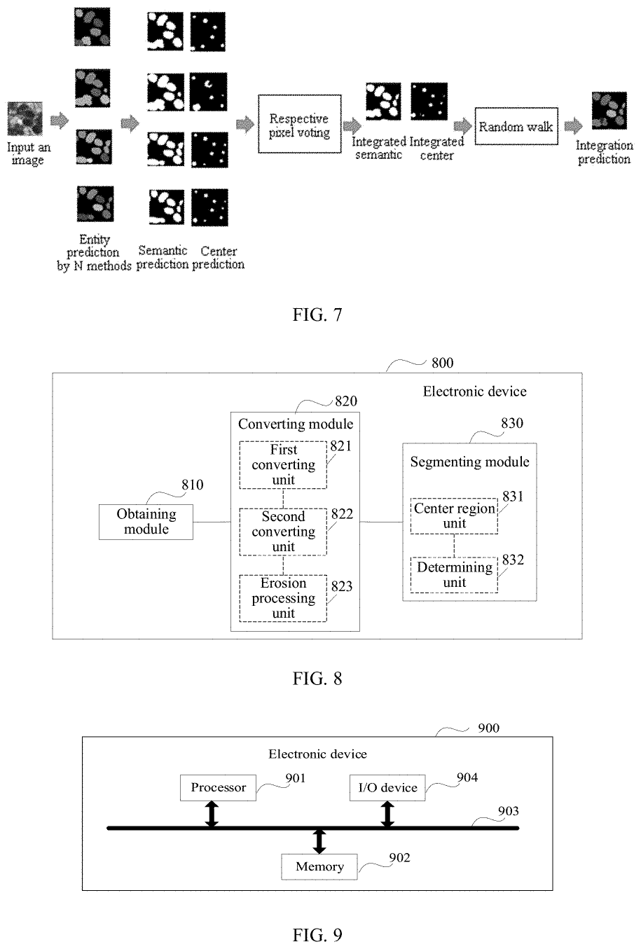

Referring to FIG. 7, FIG. 7 is a schematic diagram of an image representation of cell instance segmentation disclosed in embodiments of the present disclosure. As shown in the drawing, taking cell instance segmentation as an example, processing by the method in the embodiments of the present disclosure can obtain a more accurate instance segmentation result. N types of instance segmentation models (only 4 types are shown in the drawing) are used to separately give instance prediction masks for an input image (different colors in the drawing represent different cell instances), after converting the instance prediction masks into semantic masks using semantic prediction segmentation and center region masks using center prediction segmentation, pixel voting is performed separately, and then integration is performed to finally obtain an instance segmentation result. It can be seen that in the process, the error of missing two cells in the right three cells in method 1 is fixed, the error of adhesion of two cells in the middle in method 2 is fixed, and the fact that is not found by the four methods, i.e., there are actually three cells at the lower left corner and there is a small cell in the middle, is fixed. The integration method allows integration on any instance segmentation models, thereby combining the advantages of different methods. Through the above examples, the specific process of the foregoing embodiment and its advantages can be more clearly understood.

The above mainly introduces the solution of the embodiments of the present disclosure from the perspective of a method-side execution process. It can be understood that, in order to achieve the above functions, the electronic device includes a hardware structure and/or a software module corresponding to each function. A person skilled in the art should easily learn that, with reference to the units and algorithm steps in the examples described in the embodiments disclosed herein, the present disclosure can be implemented in hardware or a combination of hardware and computer software. Whether a certain function is performed by hardware or computer software-driven hardware depends on the particular applications and design constraint conditions of the technical solutions. For a specific application, the described functions can be implemented by a person skilled in the art using different methods, but this implementation should not be considered to go beyond the scope of the present disclosure.

In the embodiments of the present disclosure, functional units of the electronic device may be divided according to the foregoing method examples. For example, functional units may be divided corresponding to functions, or two or more functions may be integrated into one processing unit. The integrated unit may be implemented in a form of hardware and may also be implemented in a form of a software functional unit. It should be noted that the unit division in the embodiments of the present disclosure is schematic and merely logical function division, and may be actually implemented by other division modes.

Referring to FIG. 8, FIG. 8 is a schematic structural diagram of an electronic device disclosed in embodiments of the present disclosure. As shown in FIG. 8, the electronic device 800 includes: an obtaining module 810, a converting module 820, and a segmenting module 830. The obtaining module 810 is configured to obtain N groups of instance segmentation output data, wherein the N groups of instance segmentation output data are instance segmentation output results obtained by processing an image by N instance segmentation models, respectively, the N groups of instance segmentation output data have different data structures, and N is an integer greater than 1; the converting module 820 is configured to obtain integrated semantic data and integrated center region data of the image based on the N groups of instance segmentation output data, wherein the integrated semantic data indicates a pixel located in an instance region in the image, and the integrated center region data indicates a pixel located in an instance center region in the image; and the segmenting module 830 is configured to obtain an instance segmentation result of the image based on the integrated semantic data and the integrated center region data of the image.

The converting module 820 may include a first converting unit 821 and a second converting unit 822. The first converting unit 821 is configured to obtain semantic data and center region data of each of the N instance segmentation models based on the instance segmentation output data of the instance segmentation models; and the second converting unit 822 is configured to obtain the integrated semantic data and the integrated center region data of the image based on the semantic data and the center region data of each of the N instance segmentation models.

The first converting unit 821 may be specifically configured to: determine instance identification information corresponding to each of a plurality of pixels in the image in the instance segmentation model based on the instance segmentation output data of the instance segmentation model; and obtain a semantic prediction value of each of the plurality of pixels in the instance segmentation model based on the instance identification information corresponding to the pixel in the instance segmentation model, wherein the semantic data of the instance segmentation model includes the semantic prediction value of each of the plurality of pixels in the image.

The first converting unit 821 may further be specifically configured to: determine, in the instance segmentation model, at least two pixels located in the instance region in the image based on the instance segmentation output data of the instance segmentation model; determine an instance center position of the instance segmentation model based on position information of the at least two pixels located in the instance region in the instance segmentation model; and determine an instance center region of the instance segmentation model based on the instance center position of the instance segmentation model and the position information of the at least two pixels.

The converting module 820 may further include an erosion processing unit 823, configured to perform erosion processing on the instance segmentation output data of the instance segmentation model to obtain eroded data of the instance segmentation model; the first converting unit 821 may be specifically configured to determine, in the instance segmentation model, the at least two pixels located in the instance region in the image based on the eroded data of the instance segmentation model.

The first converting unit 821 may be specifically configured to use an average value of the positions of the at least two pixels located in the instance region as the instance center position of the instance segmentation model.

The first converting unit 821 may further be specifically configured to: determine a maximum distance between the at least two pixels and the instance center position based on the instance center position of the instance segmentation model and the position information of the at least two pixels; determine a first threshold based on the maximum distance; and determine a pixel in the at least two pixels which has a distance from the instance center position less than or equal to the first threshold as a pixel in the instance center region.

The converting module 820 may be specifically configured to: determine a semantic voting value of each of the plurality of pixels in the image based on the semantic data of each of the N instance segmentation models; and perform binarization processing on the semantic voting value of each of the plurality of pixels to obtain an integrated semantic value of each pixel in the image, wherein the integrated semantic data of the image includes the integrated semantic value of each of the plurality of pixels.

The converting module 820 may further be specifically configured to: determine a second threshold value based on the number N of the multiple instance segmentation models; and perform binarization processing on the semantic voting value of each of the plurality of pixels based on the second threshold to obtain the integrated semantic value of each pixel in the image.

The second threshold may be a round-up result of N/2.

The segmenting module 830 may include a center region unit 831 and a determining unit 832. The center region unit 831 is configured to obtain at least one instance center region of the image based on the integrated center region data of the image; and the determining unit 832 is configured to determine an instance to which each of the plurality of pixels in the image belongs based on the at least one instance center region and the integrated semantic data of the image.

The determining unit 832 may be specifically configured to perform a random walk based on the integrated semantic value of each of the plurality of pixels in the image and the at least one instance center region to obtain an instance to which the pixel belongs.

According to the electronic device 800 shown in FIG. 8, the electronic device 800 may obtain integrated semantic data and integrated center region data of an image based on N groups of instance segmentation output data obtained by processing the image through N instance segmentation models, and then obtain an instance segmentation result of the image based on the integrated semantic data and the integrated center region data of the image; thus, complementary advantages of the instance segmentation models can be achieved, the models are no longer required to have data outputs with the same structure or meaning, and higher accuracy can be obtained in an instance segmentation problem.

Referring to FIG. 9, FIG. 9 is a schematic structural diagram of another electronic device disclosed in embodiments of the present disclosure. As shown in FIG. 9, the electronic device 900 includes a processor 901 and a memory 902. The electronic device 900 may further include a bus 903, and the processor 901 and the memory 902 may be connected to each other through the bus 903. The bus 903 may be a Peripheral Component Interconnect (PCI) bus or an Extended Industry Standard Architecture (EISA) bus, or the like. The bus 903 may include an address bus, a data bus, a control bus, or the like. For ease of representation, only a thick line is used in FIG. 9, but it does not mean that there is only one bus or one type of bus. The electronic device 900 may further include an input-output device 904. The input-output device 904 may include a display screen, such as a liquid crystal display screen. The memory 902 is configured to store a computer program; the processor 901 is configured to call the computer program stored in the memory 902 to execute some or all of the steps of the methods mentioned in the embodiments of FIG. 1, FIG. 2, FIG. 5, and FIG. 6.

According to the electronic device 900 shown in FIG. 9, the electronic device 900 may determine an instance segmentation result of a first image based on a semantic prediction result and a center relative position prediction result of each of the plurality of pixels included in the first image, and thus, instance segmentation in image processing has the advantages of high speed and high accuracy.

According to the electronic device 900 shown in FIG. 9, the electronic device 900 may obtain integrated semantic data and integrated center region data of an image based on N groups of instance segmentation output data obtained by processing the image through N instance segmentation models, and then obtain an instance segmentation result of the image based on the integrated semantic data and the integrated center region data of the image; thus, complementary advantages of the instance segmentation models can be achieved, the models are no longer required to have data outputs with the same structure or meaning, and higher accuracy can be obtained in an instance segmentation problem.

The embodiments of the present disclosure further provides a computer storage medium, wherein the computer storage medium is configured to store a computer program, and the computer program causes a computer to perform some or all of the steps of any one of the image processing methods described in the foregoing method embodiments.

It should be noted that the foregoing method embodiments are all described as a series of action combinations for simplicity of description, but a person skilled in the art should know that the present disclosure is not limited by the sequence of actions described, because according to the present disclosure, certain steps may be performed in other sequences or simultaneously. Secondly, a person skilled in the art should also know that the embodiments described in the description are all preferred embodiments, and the actions and modules involved are not necessarily required by the present disclosure.

In the foregoing embodiments, description of the embodiments all have their own focuses, and for portions that are not described in detail in a certain embodiment, reference may be made to the related description in other embodiments.

It should be understood that the disclosed apparatus in the several embodiments provided in the present disclosure may be implemented by other modes. For example, the apparatus embodiments described above are merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by means of some interfaces. The indirect couplings or communication connections between the apparatuses or units may be implemented in electronic or other forms.

The units (modules) described as separate parts may or may not be physically separate, and the parts displayed as units may or may not be physical units, may be located in one position, or may be distributed on a plurality of network units. Some of or all of the units may be selected according to actual needs to achieve the objectives of the solutions of the embodiments.

In addition, functional units in the embodiments of the present discourse may be integrated into one processing unit, or each of the units may exist alone physically, or two or more units may be integrated into one unit. The integrated unit may be implemented in a form of hardware and may also be implemented in a form of a software functional unit.

When the integrated unit is implemented in a form of a software functional unit and sold or used as an independent product, the integrated unit may be stored in a computer-readable memory. Based on such an understanding, the technical solutions of the present disclosure, or a part thereof contributing to the prior art, or all or a part of the technical solutions may be embodied in the form of a software product. The computer software product is stored in one memory and includes several instructions so that one computer device (which may be a personal computer, a server, a network device, or the like) implements all or some of steps of the methods in the embodiments of the present disclosure. Moreover, the preceding memory includes: media having program codes stored such as a USB flash drive, a Read-only Memory (ROM), a Random Access Memory (RAM), a mobile hard disk drive, a magnetic disk, or an optical disc.

A person of ordinary skill in the art may understand that all or some of the steps in the methods of the foregoing embodiments may be completed by a program instructing related hardware. The program may be stored in a computer-readable memory, and the memory may include: a flash disk, a ROM, an RAM, a magnetic disk, an optical disk, or the like.

The embodiments of the present disclosure are described in detail above. Specific examples are used herein to explain the principles and implementations of the present disclosure, and the description of the above embodiments is only used to help understand the methods and core concepts of the present disclosure. Moreover, for a person of ordinary skill in the art, according to the concept of the present disclosure, there will be changes in the specific implementation and the scope of application. In summary, the content of this description should not be construed as a limitation on the present disclosure.

1. An image processing method, comprising:
obtaining respective prediction results of a plurality of pixels in a first image by processing the first image, each of the prediction results comprising a semantic prediction result and a center relative position prediction result, wherein the semantic prediction result indicates that the pixel is located in an instance region or in a background region, and the center relative position prediction result indicates a relative position between the pixel and an instance center; and
determining an instance segmentation result of the first image based on the semantic prediction result and the center relative position prediction result of each of the plurality of pixels.

2. The image processing method according to claim 1, wherein before processing the first image, the method further comprises:
obtaining the first image by preprocessing a second image, so that the first image satisfies a preset contrast ratio and/or a preset grayscale value.

3. The image processing method according to claim 1, wherein determining the instance segmentation result of the first image based on the semantic prediction result and the center relative position prediction result of each of the plurality of pixels comprises:
determining at least one first pixel located in the instance region from the plurality of pixels based on the semantic prediction result of each of the plurality of pixels; and
determining, for each first pixel, an instance to which the first pixel belongs based on the center relative position prediction result of the first pixel.

4. The image processing method according to claim 3, wherein
each of the prediction result further comprises a center region prediction result, and the center region prediction result indicates whether the pixel is located in an instance center region;
the method further comprises: determining at least one instance center region of the first image based on the center region prediction result of each of the plurality of pixels; and
determining the instance to which the first pixel belongs based on the center relative position prediction result of the first pixel comprises: determining an instance center region corresponding to the first pixel from the at least one instance center region based on the center relative position prediction result of the first pixel.

5. The image processing method according to claim 4, wherein determining the at least one instance center region of the first image based on the center region prediction result of each of the plurality of pixels comprises:
obtaining the at least one instance center region by performing connected component search processing on the first image based on the center region prediction result of each of the plurality of pixels.

6. The image processing method according to claim 4, wherein determining the instance center region corresponding to the first pixel from the at least one instance center region based on the center relative position prediction result of the first pixel comprises:
determining a center prediction position of the first pixel based on position information of the first pixel and the center relative position prediction result of the first pixel, wherein the center prediction position indicates a predicted center position of an instance center region to which the first pixel belongs; and
determining the instance center region corresponding to the first pixel from the at least one instance center region based on the center prediction position of the first pixel and position information of the at least one instance center region.

7. The image processing method according to claim 6, wherein determining the instance center region corresponding to the first pixel from the at least one instance center region based on the center prediction position of the first pixel and the position information of the at least one instance center region comprises:
in response to the center prediction position of the first pixel belonging to a first instance center region in the at least one instance center region, determining the first instance center region as the instance center region corresponding to the first pixel; or
in response to the center prediction position of the first pixel not belonging to any instance center region in the at least one instance center region, determining, in the at least one instance center region, an instance center region closest to the center prediction position of the first pixel as the instance center region corresponding to the first pixel.

8. The image processing method according to claim 4, wherein obtaining the prediction results of the plurality of pixels in the first image by processing the first image comprises:
obtaining respective center region prediction probabilities of the plurality of pixels in the first image by processing the first image; and
obtaining the center region prediction result of each of the plurality of pixels by performing binarization processing on the respective center region prediction probabilities of the plurality of pixels based on a first threshold.

9. An electronic device, comprising:
a processor; and
a memory for storing a computer readable program executable by the processor,
wherein the processor is configured to:
obtain respective prediction results of a plurality of pixels in a first image by processing the first image, each of the prediction results comprising a semantic prediction result and a center relative position prediction result, wherein the semantic prediction result indicates that the pixel is located in an instance region or in a background region, and the center relative position prediction result indicates a relative position between the pixel and an instance center; and
determine an instance segmentation result of the first image based on the semantic prediction result and the center relative position prediction result of each of the plurality of pixels.

10. The electronic device according to claim 9, wherein determining the instance segmentation result of the first image based on the semantic prediction result and the center relative position prediction result of each of the plurality of pixels comprises:
determining at least one first pixel located in the instance region from the plurality of pixels based on the semantic prediction result of each of the plurality of pixels; and
determining an instance to which each first pixel belongs based on the center relative position prediction result of each first pixel.

11. An image processing method, comprising:
obtaining N groups of instance segmentation output data, wherein the N groups of instance segmentation output data are instance segmentation output results obtained by processing an image by N instance segmentation models, respectively, the N groups of instance segmentation output data have different data structures, and N is an integer greater than 1;
obtaining integrated semantic data and integrated center region data of the image based on the N groups of instance segmentation output data, wherein the integrated semantic data indicates a pixel located in an instance region in the image, and the integrated center region data indicates a pixel located in an instance center region in the image; and
obtaining an instance segmentation result of the image based on the integrated semantic data and the integrated center region data of the image.

12. The image processing method according to claim 11, wherein obtaining the integrated semantic data and the integrated center region data of the image based on the N groups of instance segmentation output data comprises:
obtaining, for each of the N instance segmentation models, semantic data and center region data of the instance segmentation model based on the instance segmentation output data of the instance segmentation model; and
obtaining the integrated semantic data and the integrated center region data of the image based on the semantic data and the center region data of each of the N instance segmentation models.

13. The image processing method according to claim 12, wherein obtaining the semantic data and the center region data of the instance segmentation model based on the instance segmentation output data of the instance segmentation model comprises:
determining instance identification information corresponding to each of a plurality of pixels in the image in the instance segmentation model based on the instance segmentation output data of the instance segmentation model; and
obtaining a semantic prediction value of each of the plurality of pixels in the instance segmentation model based on the instance identification information corresponding to each of the plurality of pixels in the instance segmentation model, wherein the semantic data of the instance segmentation model comprises the semantic prediction value of each of the plurality of pixels in the image.

14. The image processing method according to claim 12, wherein obtaining the semantic data and the center region data of the instance segmentation model based on the instance segmentation output data of the instance segmentation model further comprises:
determining, in the instance segmentation model, at least two pixels located in the instance region in the image based on the instance segmentation output data of the instance segmentation model;
determining an instance center position of the instance segmentation model based on position information of the at least two pixels located in the instance region in the instance segmentation model; and
determining an instance center region of the instance segmentation model based on the instance center position of the instance segmentation model and the position information of the at least two pixels.

15. The image processing method according to claim 14, wherein
before determining, in the instance segmentation model, the at least two pixels located in the instance region in the image based on the instance segmentation output data of the instance segmentation model, the method further comprises:
obtaining eroded data of the instance segmentation model by performing erosion processing on the instance segmentation output data of the instance segmentation model; and
determining, in the instance segmentation model, the at least two pixels located in the instance region in the image based on the instance segmentation output data of the instance segmentation model comprises:
determining, in the instance segmentation model, the at least two pixels located in the instance region in the image based on the eroded data of the instance segmentation model.

16. The image processing method according to claim 14, wherein determining the instance center position of the instance segmentation model based on the position information of the at least two pixels located in the instance region in the instance segmentation model comprises:
taking an average value of the positions of the at least two pixels located in the instance region as the instance center position of the instance segmentation model.

17. The image processing method according to claim 14, wherein determining the instance center region of the instance segmentation model based on the instance center position of the instance segmentation model and the position information of the at least two pixels comprises:
determining a maximum distance among the at least two pixels and the instance center position based on the instance center position of the instance segmentation model and the position information of the at least two pixels;
determining a first threshold based on the maximum distance; and
determining a pixel in the at least two pixels which has a distance from the instance center position being less than or equal to the first threshold as a pixel in the instance center region.

18. An electronic device, comprising:
a processor; and
a memory for storing a computer readable program executable by the processor,
wherein the processor is configured to:
obtain N groups of instance segmentation output data, wherein the N groups of instance segmentation output data are instance segmentation output results obtained by processing an image by N instance segmentation models, respectively, the N groups of instance segmentation output data have different data structures, and N is an integer greater than 1;
obtain integrated semantic data and integrated center region data of the image based on the N groups of instance segmentation output data, wherein the integrated semantic data indicates a pixel located in an instance region in the image, and the integrated center region data indicates a pixel located in an instance center region in the image; and
obtain an instance segmentation result of the image based on the integrated semantic data and the integrated center region data of the image.

19. The electronic device according to claim 18, wherein obtaining the integrated semantic data and the integrated center region data of the image based on the N groups of instance segmentation output data comprises:
obtaining, for each of the N instance segmentation models, semantic data and center region data of the instance segmentation model based on the instance segmentation output data of the instance segmentation model; and
obtaining the integrated semantic data and the integrated center region data of the image based on the semantic data and the center region data of each of the N instance segmentation models.

20. The electronic device according to claim 19, wherein obtaining the semantic data and the center region data of the instance segmentation model based on the instance segmentation output data of the instance segmentation model comprises:
determining, in the instance segmentation model, at least two pixels located in the instance region in the image based on the instance segmentation output data of the instance segmentation model;
determining an instance center position of the instance segmentation model based on position information of the at least two pixels located in the instance region in the instance segmentation model; and
determining an instance center region of the instance segmentation model based on the instance center position of the instance segmentation model and the position information of the at least two pixels.
